(19) United States
(12) Patent Application Publication
(10) Pub. No.: US 2004/0107264 A1
(43) Pub. Date: Jun. 3, 2004

(54) Computer system and memory control method

(76) Inventor: Yoshihiro Nishida, Akishima-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/642,744

(22) Filed: Aug. 19, 2003

(30) Foreign Application Priority Data
Aug. 20, 2002 (JP) 2002-239548

(51) Int. Cl. G06F 15/167

(52) U.S. Cl. 709/213

(57) ABSTRACT

A computer system has two CPUs. A shared memory exchanges data between the two CPUs. When the first CPU writes data in the shared memory, an address determination unit determines whether the address of the written data is in a predetermined area. A significance determination unit determines whether the written data is significant that should be immediately processed by the second CPU. If the address determination unit and the significance determination unit determine that the address is in the predetermined area and that the data is significant, an interrupt signal is supplied to an interrupt controller.

### CROSS-REFERENCE TO RELATED APPLICATIONS

This application is based upon and claims the benefit of priority from the prior Japanese Patent Application No. 2002-239548, filed Aug. 20, 2002, the entire contents of which are incorporated herein by reference.

### BACKGROUND OF THE INVENTION

1. Field of the Invention

The present invention relates to a computer system having a memory accessed from a plurality of CPU and a memory control method of the system, and particularly to a computer system, which efficiently exchanges data between a plurality of CPUs via a memory and a memory control method of the system.

2. Description of the Related Art

In recent years, a computer system having a plurality of CPUs has been widespread in order to deal with data which require a complicated process or immediacy, such as image data, voice data or network data (the system may be made up of a single computer having a plurality of CPUs, or a plurality of computers each having a single CPU). A so-called shared memory (dual port memory) is used to exchange data between the CPUs.

When data is exchanged between CPUs via the shared memory, in order for a first CPU to read data written by a second CPU, the system requires a function of detecting that the second CPU writes data or a function for notifying the first CPU that the data is written.

Generally, therefore, in the conventional system, each CPU executes, at a predetermined timing, polling (reading) of a specific address agreed upon with another CPU. Otherwise, as disclosed in, for example, Jpn. Pat. Appln. KOKOKU Publication No. 60-20779, when a CPU writes data in a specific address, it causes the counterpart CPU to generate an interrupt, thereby notifying the counterpart CPU that the data is written.

However, the above method by means of the polling has the following problems. 1) Since each CPU executes the polling at the predetermined timing, it cannot promptly read data, which requires immediacy, written by another CPU. 2) Since access for the polling must be executed frequently regardless of whether another CPU writes data or not, the frequency of competition with the access from another CPU is increased. Therefore, the access for the polling may be withheld, with the result that the response time (access latency) is prolonged.

The above method by means of the interrupt has the following problem. Each time a CPU is to cause an interrupt process to start, an interrupt handler must be activated. Therefore, the load of the CPU notified that data is written is increased, the data process in the CPU delays.

### BRIEF SUMMARY OF THE INVENTION

According to an aspect of the invention, a computer system comprises a memory, a first CPU which writes writing data into the memory, a second CPU, and a controller which instructs the second CPU to process the writing data based on attribute data representing an attribute of the writing data.

An advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a structure relating to a shared memory control of a computer system according to a first embodiment of the present invention;

FIG. 2 is a flow chart showing operation procedures relating to the shared memory control of the computer system according to the first embodiment;

FIG. 3 is a diagram showing a structure relating to a shared memory control of a computer system according to a second embodiment of the present invention;

FIG. 4 is a flow chart showing operation procedures relating to the shared memory control of the computer system according to the second embodiment;

FIG. 5 is a diagram showing a structure relating to shared memory control of a computer system according to a third embodiment of the present invention;

FIG. 6 is a diagram showing an example of addresses and attribute data stored in a write register of a computer system of the third embodiment;

FIG. 7 is a flow chart showing operation procedures relating to the shared memory control of the computer system according to the third embodiment;

FIG. 8 is a diagram showing a structure relating to a shared memory control of a computer system according to a fourth embodiment of the present invention; and

FIG. 9 is a flow chart showing operation procedures relating to the shared memory control of the computer system according to the fourth embodiment.

### DETAILED DESCRIPTION OF THE INVENTION

Embodiments of the present invention will be described below with reference to the accompanying drawings.

(First Embodiment)

First, the first embodiment of the present invention will be described.

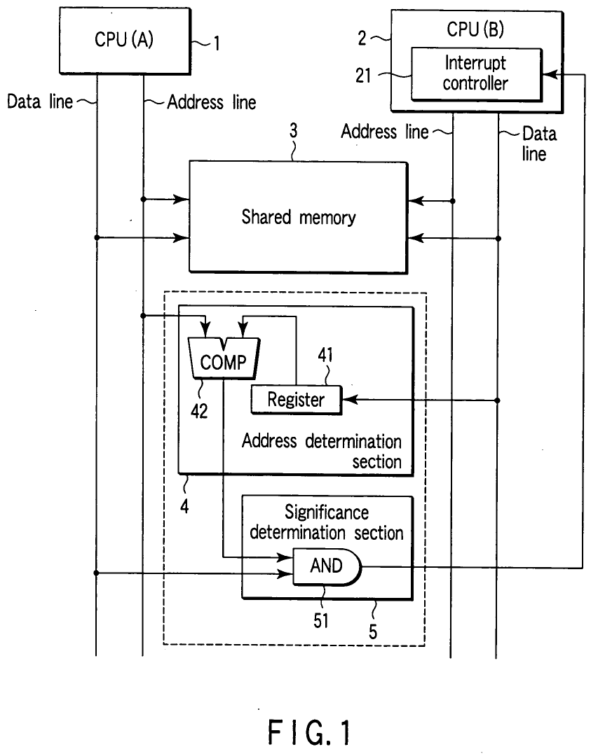

FIG. 1 is a diagram showing a structure relating to a shared memory control of a computer system according to the first embodiment of the present invention.

As shown in FIG. 1, the computer system has two CPUs: a CPU (A) 1 and a CPU (B) 2. To exchange data between the two CPUs, the computer system has a shared memory 3 shared by the CPU (A) 1 and the CPU (B) 2. In this embodiment, it is assumed that, for example, the CPU (A) 1 receives image data through a network and transfers the image data to the CPU (B) to make it execute a process for reproducing the image data. In other words, it is assumed that significant data which requires immediacy is exchanged via the shared memory 3.

In this case, the programs operating in the CPU (A) 1 and the CPU (B) 2 predetermine what area of the shared memory 3 should be used to exchange data (the area agreed upon between the CPUs). The CPU (B) 2 stores data representing an address range of the determined area in a register 41 of an address determination section 4.

When the CPU (A) 1 writes data in the shared memory 3, the address determination section 4 determines whether the address of an area in which the data is written (hereinafter referred to as “the target address”) is in the predetermined area agreed upon between the CPU (A) 1 and the CPU (B) 2. A comparator 42 receives the target address through an address line, and compares it with the data stored in the register 41. The comparator 42 is configured to output an active signal when the target address falls within the area agreed upon between the CPU (A) 1 and the CPU (B) 2, i.e., matches with the address range represented by the data stored in the register 41. The active signal output from the comparator 42 is supplied to an AND circuit 51 of a significance determination section 5.

When the CPU (A) 1 writes data in the shared memory 3, the significance determination section 5 determines whether the written data is significant data that should be immediately processed by the CPU (B). The AND circuit 51 outputs an interrupt signal to an interrupt controller 21 incorporated in the CPU (B) 2, when a predetermined bit of the written data output to the data line is “1” and the comparator 42 outputs the active signal.

When the program operating in the CPU (A) writes, for example, image data in the shared memory 3, it attaches attribute data that has been agreed upon with the program operating in the CPU (B) 2 to a predetermined position of the written data. A predetermined bit of the attribute data stores information representing the degree of significance of the written data. More specifically, when the written data is significant data that should be immediately processed by the CPU (B), the predetermined bit stores “1”. The significance determination section 5 receives the predetermined bit of the attribute data attached to the predetermined position of the written data and supplies it to the AND circuit 51.

When the address determination section 4 determines that the target address falls within the area agreed upon with the CPU (B) 2 and the significance determination section 5 determines that the written data is significant data that should be immediately processed by the CPU (B), the interrupt signal is supplied to the interrupt controller 21 in the CPU (B) 2. The interrupt controller 21 generates an interrupt, causing the CPU (B) 2 to activate the interrupt handler. Thus, it informs the CPU (B) 2 of the cause of the interrupt, i.e., the fact that the CPU (A) 1 wrote the data in the shared memory 3.

As a result, the CPU (B) recognizes that the CPU (A) 1 wrote the data in the shared memory 3. Immediately after the interrupt process is completed and the process before the interrupt is resumed, the CPU (B) executes a process of reading the significant data written in the shared memory 3.

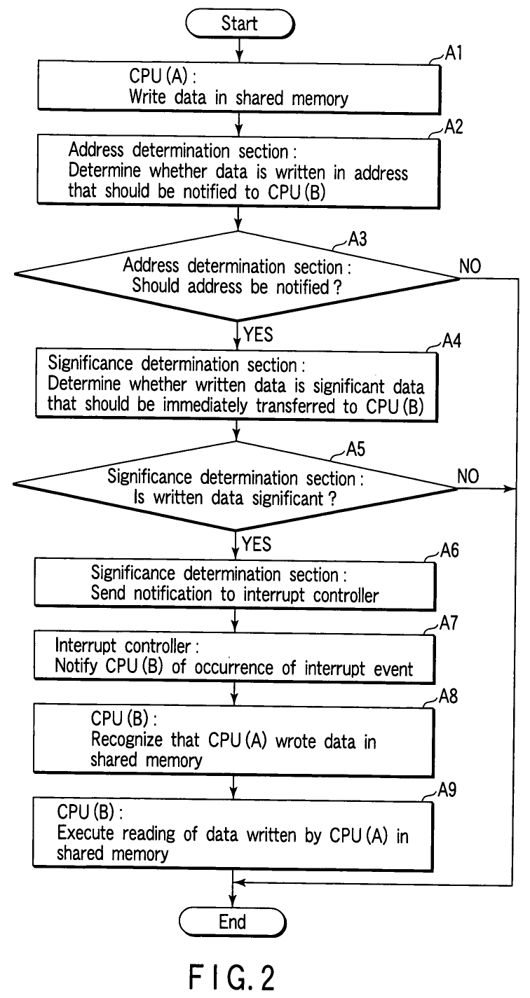

FIG. 2 is a flow chart showing operation procedures relating to the shared memory control of the computer system according to the first embodiment.

When the CPU (A) 1 writes data in the shared memory 3 (step Al), the address determination section 4 determines whether the data is written in an address that should be notified to the CPU (B) (step A2). If the address determination section 4 determines that the address should be notified to the CPU (B) (YES in step A3), the significance determination section 5 determines whether the written data is significant data that should be immediately transferred to the CPU (B) 2 (step A4). If the significance determination section 5 determines that the written data is significant data (YES in step A5), it sends a notification to the interrupt controller 21 (step A6).

The interrupt controller 21, which receives the notification, notifies the CPU (B) 2 of the occurrence of an interrupt event (step A7). As a result, the CPU (B) recognizes that the CPU (A) 1 wrote the data in the shared memory 3 (step A8). Immediately after the process before the interrupt is resumed, the CPU (B) executes a process of reading the significant data written by the CPU (A) 1 in the shared memory 3 (step A9).

The address determination section 4 and the significance determination section 5 may determine that the data written in the shared memory 3 by the CPU (A) 1 need not be sent to the interrupt controller 21, i.e., determine that the written data is insignificant. In this case, for example, when significant data is written later, the insignificant data is recognized by the CPU (B) along with the significant data. Otherwise, the insignificant data is recognized and read by the CPU (B) 2 in the polling executed, for example, during idle time of the CPU (B) 2 or when the access from the CPU (B) 2 to the shared memory 3 stops over a predetermined time.

Thus, the computer system of the first embodiment has the determination means for notifying only significant data by an interrupt. An interrupt by insignificant data is prohibited, and the interval of polling for only insignificant data is set to a relatively long term. In this way, unneeded access competition and the load of the CPU due to the interrupt handler can be reduced. The interval of the polling is software-settable by means of the operating system or utility program operating on, for example, the CPU (B) 2.

(Second Embodiment)

The second embodiment of the present invention will now be described.

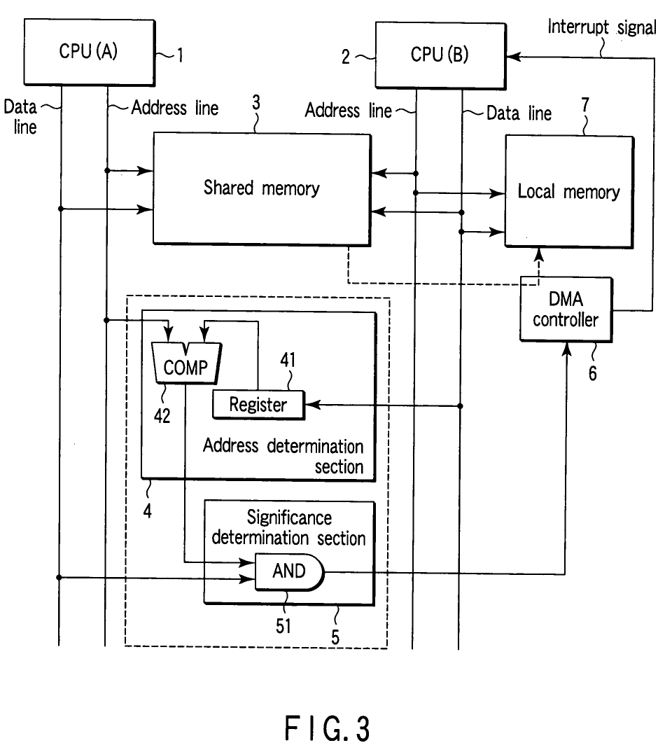

FIG. 3 is a diagram showing a structure relating to shared memory control of a computer system according to the second embodiment of the present invention.

The second embodiment is different from the first embodiment in that the significance determination section 5 sends a notification to a DMA controller 6, as shown in FIG. 3. When the DMA controller 6 receives the notification, it reads data written by the CPU (A) 1 from the shared memory, and writes the data in a local memory 7 in the CPU (B) 2. In other words, the DMA controller 6 executes data transfer from the shared memory 3 to the local memory 7 only when significant data is written. After the data transfer is completed, the DMA controller 6 notifies the CPU (B) 2 of the data transfer by means of an interrupt signal.

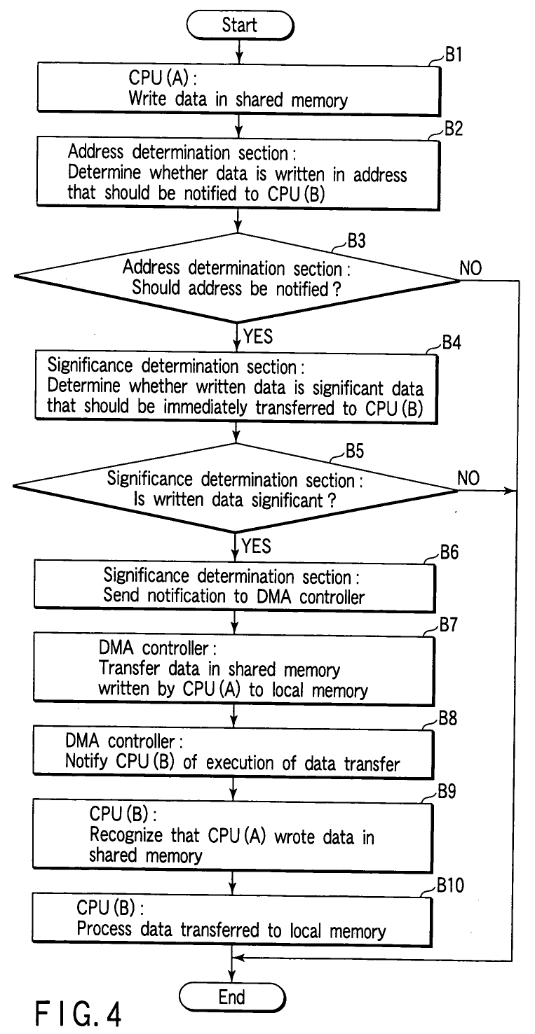

FIG. 4 is a flow chart showing operation procedures relating to the shared memory control of the computer system according to the second embodiment..

When the CPU (A) 1 writes data in the shared memory 3 (step B1), the address determination section 4 determines whether the data is written in an address that should be notified to the CPU (B) (step B2). If the address determination section 4 determines that the address should be notified to the CPU (B) (YES in step B3), the significance determination section 5 determines whether the written data is significant data that should be immediately transferred to the CPU (B) 2 (step B4). If the significance determination section 5 determines that the written data is significant data (YES in step B5), it sends a notification to the DMA controller 6 (step B6).

The DMA controller 6, which receives the notification, transfers the data in the shared memory 3 written by the CPU (A) to the local memory 7 (step B7). After the completion of the transfer, it notifies the CPU (B) 2 of the execution of the data transfer (step B8). Owing to the notification, the CPU (B) recognizes that the CPU (A) 1 wrote the data in the shared memory 3 (step B9), and processes the data transferred to the local memory 7 (step B10).

According to the computer system of the second embodiment, as well as in the first embodiment, DMA activation by insignificant data is prohibited, and the interval of polling for only insignificant data is set to a relatively long term. In this way, unneeded access competition and the load of the CPU due to the DMA activation can be reduced. In addition, even if only a limited area is ensured in the shared memory 3 for the purpose of data exchange between, for example, the CPU (A) 1 and the CPU (B) 2, the CPU (1) can successively write new data when the data transfer to the local memory 7 by means of the DMA controller 6 is completed, before the processing by the CPU (B) is completed.

(Third Embodiment)

The third embodiment of the present invention will now be described.

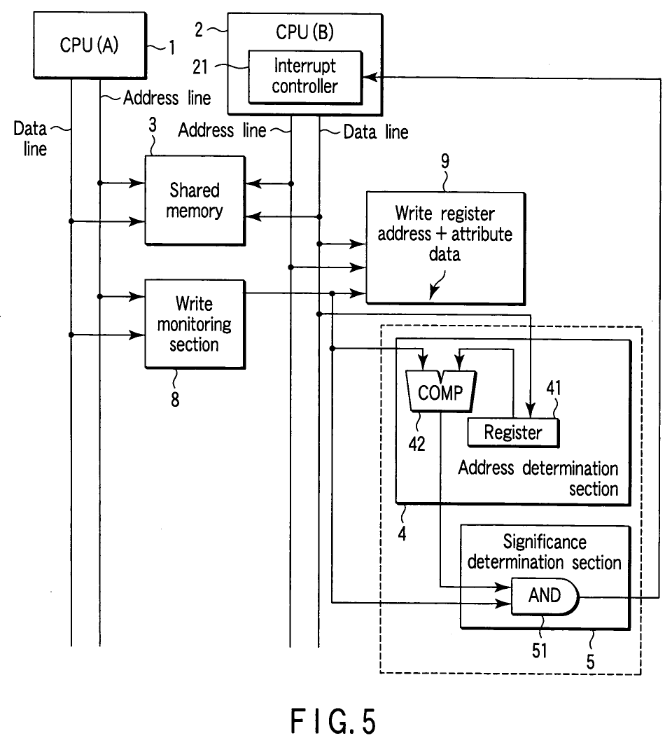

FIG. 5 is a diagram showing a structure relating to shared memory control of a computer system according to the third embodiment of the present invention.

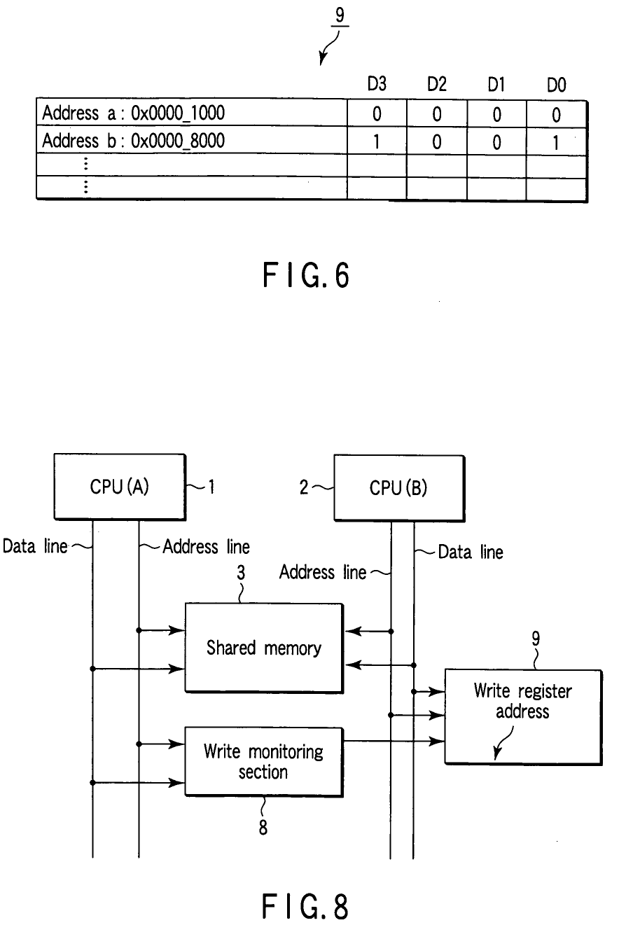

The third embodiment is different from the first embodiment in that a write monitoring section 8 and a write register 9 are additionally provided, as shown in FIG. 5. The write monitoring section 8 monitors whether the CPU (A) 1 executes data writing in the shared memory 3. When it detects that the data writing is executed, it stores in the write register 9 the address of an area of the shared memory where the data is written and attribute data attached to the predetermined position of the written data. FIG. 6 shows an example of addresses and attribute data stored in the write register 9. In the figure, D0 to D3 denote attribute data attached to the respective data. For example, D0 represents the presence or absence of an interrupt request, D1 represents the presence or absence of a DMA request, and D2 and D3 represent a notification of written contents and status information agreed upon in advance between the CPUs. In this case, the data written in an address (a) does not cause the CPU (B) 2 to generate an interrupt, but data written in an address (b) does. The CPU (B) 2 recognizes the two data writing processes.

Further, in the computer system of the third embodiment, the address determination section 4 and the significance determination section 5 determines whether to supply an interrupt signal to the interrupt controller 21, utilizing the address and the attribute data which the write monitoring section writes in the write register 9.

Furthermore, in the computer system of the third embodiment, the CPU (B) 2 recognizes, through the generation of an interrupt by the interrupt controller 21, that the CPU (A) 1 wrote data in the shared memory 3. At this time, the CPU (B) 2 refers to the write register 9. Then, it executes minimum access to the shared memory 3 based on the address and the attribute data stored in the write register 9.

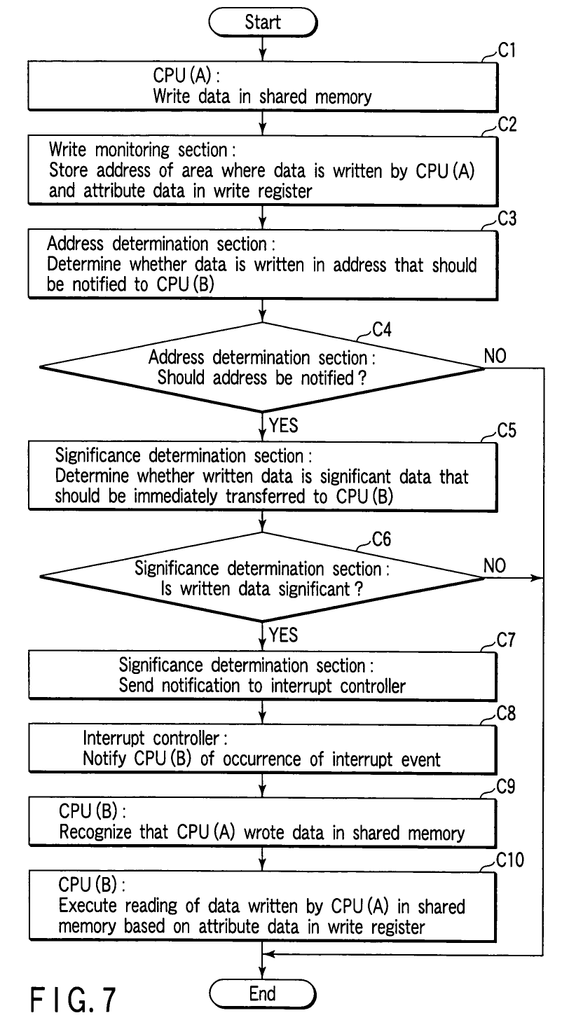

FIG. 7 is a flow chart showing operation procedures relating to the shared memory control of the computer system according to the third embodiment.

When the CPU (A) 1 writes data in the shared memory 3 (step C1), the write monitoring section 8 stores the target address and the attribute data in the write register 9 (step C2).

The address determination section 4 determines whether the data is written in an address that should be notified to the CPU (B) (step C3). If the address determination section 4 determines that the address should be notified to the CPU (B) (YES in step C4), the significance determination section 5 determines whether the written data is significant data that should be immediately transferred to the CPU (B) 2 (step C5). If the significance determination section 5 determines that the written data is significant data (YES in step C6), it sends a notification to the interrupt controller 21 (step C7).

The interrupt controller 21, which receives the notification, notifies the CPU (B) 2 of the occurrence of an interrupt event (step C8). As a result, the CPU (B) 2 recognizes that the CPU (A) 1 wrote the data in the shared memory 3 (step C9). Immediately after the process before the interrupt is resumed, the CPU (B) 2 executes a process of reading the data written by the CPU (A) 1 in the shared memory 3 based on the attribute data in the write register 9 (step C10).

According to the computer system of the third embodiment, as well as in the first embodiment, an interrupt by insignificant data is prohibited, and the load of the CPU due to the interrupt handler can be reduced. In addition, since the written data is read out based on data in the register 9, the access to the shared memory 3 can be considerably reduced. Moreover, since the polling for only insignificant data is carried out with respect to the write register 9, the access competition can be further reduced.

In the above description, the control of whether or not a notification is sent to the interrupt controller 21 has been explained. However, flexible control can be carried out; for example, since the attribute data of the respective data are stored in the write register 9, whether to send a notification to the DMA controller may be determined separately utilizing the attribute data.

(Fourth Embodiment)

The fourth embodiment of the present invention will now be described.

FIG. 8 is a diagram showing a structure relating to a shared memory control of a computer system according to the fourth embodiment of the present invention.

In the computer system of the fourth embodiment, the CPU (B) 2 recognizes that the CPU (A) 1 wrote data in the shared memory 3 only by polling. To efficiently carry out the polling by the CPU (B) 2, the compute system of the fourth embodiment has the write monitoring section 8 and the write register 9 of the third embodiment described above. In other words, according to the fourth embodiment, the CPU (B) 2 executes polling with respect to the write register 9. In the fourth embodiment, the write monitoring section 8 stores only addresses in the write register 9.

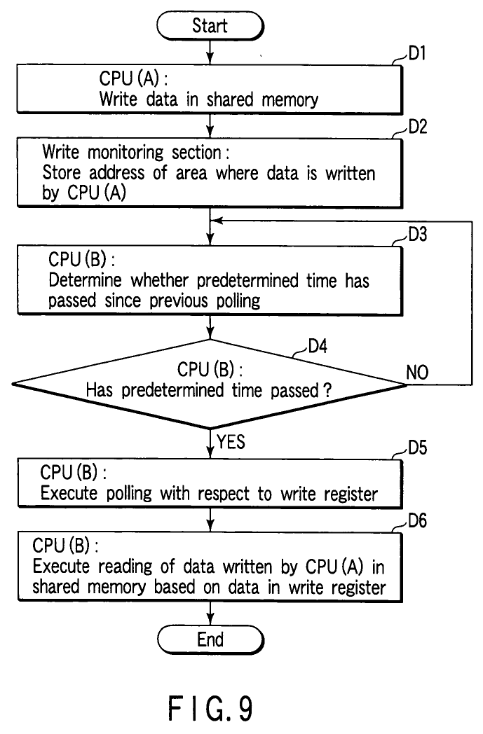

FIG. 9 is a flow chart showing operation procedures relating to the shared memory control of the computer system according to the fourth embodiment.

When the CPU (A) 1 writes data in the shared memory 3 (step D1), the write monitoring section 8 stores the target address in the write register 9 (step D2).

The CPU (B) 2 determines, for example, whether a predetermined time has passed since the previous polling (YES in step D3). If the predetermined time has passed (YES in step D4), the CPU (B) 2 carries out polling with respect to the write register 9 (step D5). Then, the CPU (B) 2 reads data written by the CPU (A) 1 in the shared memory 3 based on data in the write register 9 (step D6).

According to the computer system of the fourth embodiment, since the written data is carried out based on the register 9, the access to the shared memory 3 can be considerably reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A computer system comprising:
a memory;
a first processor which writes writing data into the memory;
a second processor; and
a controller which instructs the second processor to process the writing data based on attribute data representing an attribute of the writing data.

2. The computer system according to claim 1, wherein the attribute data comprises information representing a degree of significance of the writing data.

3. The computer system according to claim 2, wherein the controller instructs the second processor to process the writing data when the attribute data represents a degree of significance which is higher that a predetermined degree of significance.

4. The computer system according to claim 1, wherein the controller comprises an interrupt detector which is incorporated in the second processor and instructs to process the writing data when an interruption is detected.

5. The computer system according to claim 1, wherein the controller comprises a direct memory controller which performs a transfer of the writing data written by the first processor into the memory to a local memory of the second processor, and after the transfer, notifies the second processor that the transfer is completed.

6. The computer system according to claim 1, wherein the determination unit comprises an address determination unit that determines whether an address on the memory into which the writing data is written by the first processor is in a predetermined area.

7. A computer system comprising:
a memory;
a first processor which writes writing data into the memory;
a second processor;
a register; and
a write detecting unit which detects that the first processor writes the writing data into the memory and stores in the register an address on the memory of the writing data,
wherein the second processor reads the writing data based on the address stored in the register.

8. The computer system according to claim 7, further comprising:
a controller which instructs the second processor to process the writing data when the address is stored in the register.

9. A memory control method for controlling a computer system comprising a memory, a first processor which writes writing data into the memory, a second processor, and a controller which instructs the second processor to process the writing data, the method comprising:
receiving attribute data representing an attribute of the writing data from the first processor; and
determining whether the controller instructs the second processor to process the writing data based on the attribute data.

10. A memory control method for controlling a computer system comprising a memory, a first processor which writes writing data into the memory, a second processor, a register, and write monitoring means which stores in the register an address on the memory of the writing data,
wherein the second processor reads the writing data. based on the address stored in the register.
